(19) United States
(12) Patent Application Publication
(10) Pub. No.: US 2025/0016634 A1
(43) Pub. Date: Jan. 9, 2025

(54) METHOD AND USER EQUIPMENT FOR CONDITIONAL HANDOVER IN MULTI-RAT DUAL CONNECTIVITY NETWORK

(71) Applicant: FG Innovation Company Limited, Tuen Mun (HK)

(72) Inventors: HE-HSUAN LIU, Taipei (TW); MEI-JU SHIH, Taipei (TW); CHIA-HUNG LIN, Taipei (TW)

(21) Appl. No.: 18/764,764

(22) Filed: Jul. 5, 2024

Related U.S. Application Data
(60) Provisional application No. 63/525,292, filed on Jul. 6, 2023.

(51) Int. Cl. H04W 36/00; H04W 36/36

(52) U.S. Cl. CPC H04W 36/00698; H04W 36/362

(57) ABSTRACT

A method performed by a UE for a conditional handover (CHO) in an MR-DC network is provided. The method receives a message including an execution condition for a PCell, a first SCG configuration for a first PSCell, an execution condition for the first PSCell, and a second SCG configuration for a second PSCell. The method stores the first SCG configuration and the second SCG configuration. The method determines whether the execution condition for the PCell is satisfied and whether the execution condition for the first PSCell is satisfied. The method applies the first SCG configuration after determining that the execution condition for the PCell is satisfied and the execution condition for the first PSCell is satisfied. The method applies the second SCG configuration after determining that the execution condition for the PCell is satisfied and the execution condition for the first PSCell is not satisfied.

### CROSS-REFERENCE TO RELATED APPLICATION(S)

The present disclosure claims the benefit of and priority to U.S. Provisional Patent Application Ser. No. 63/525,292, filed on Jul. 6, 2023, entitled “METHOD AND APPARATUS FOR CONDITIONAL HANDOVER WITH CANDIDATE SECONDARY CELL GROUPS,” the content of which is hereby incorporated herein fully by reference into the present disclosure for all purposes.

### FIELD

The present disclosure is related to wireless communication and, more specifically, to a method and a user equipment (UE) for a conditional handover (CHO) in a multi-radio access technology (RAT) dual connectivity (MR-DC) network in cellular wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communications in the next-generation wireless communication systems.

### SUMMARY

The present disclosure is related to a method and a user equipment (UE) for a conditional handover (CHO) in a multi-RAT dual connectivity (MR-DC) network in cellular wireless communication networks.

In a first aspect of the present application, a method performed by a UE for a conditional handover (CHO) in a multi-RAT dual connectivity (MR-DC) network is provided. The method includes receiving a message including an execution condition for a primary cell (PCell), a first secondary cell group (SCG) configuration for a first primary secondary cell (PSCell), an execution condition for the first PSCell, and a second SCG configuration for a second PSCell; storing the first SCG configuration and the second SCG configuration; determining whether the execution condition for the PCell is satisfied and whether the execution condition for the first PSCell is satisfied; applying the first SCG configuration after determining that the execution condition for the PCell is satisfied and the execution condition for the first PSCell is satisfied; and applying the second SCG configuration after determining that the execution condition for the PCell is satisfied and the execution condition for the first PSCell is not satisfied.

In an implementation of the first aspect, the method further includes connecting, based on the first SCG configuration, to the first PSCell after determining that the execution condition for the PCell is satisfied and the execution condition for the first PSCell is satisfied.

In another implementation of the first aspect, the method further includes connecting, based on the second SCG configuration, to the second PSCell after determining that the execution condition for the PCell is satisfied and the execution condition for the first PSCell is not satisfied.

In another implementation of the first aspect, receiving the message includes receiving the message via radio resource control (RRC) signaling.

In a second aspect of the present application, a UE for a conditional handover (CHO) in a multi-RAT dual connectivity (MR-DC) network is provided. The UE includes one or more processors; and at least one non-transitory computer-readable medium coupled to the one or more processors, and storing one or more computer-executable instructions that, when executed by the one or more processors, cause the UE to receive a message including an execution condition for a primary cell (PCell), a first secondary cell group (SCG) configuration for a first primary secondary cell (PSCell), an execution condition for the first PSCell, and a second SCG configuration for a second PSCell; store the first SCG configuration and the second SCG configuration; determine whether the execution condition for the PCell is satisfied and whether the execution condition for the first PSCell is satisfied; apply the first SCG configuration after determining that the execution condition for the PCell is satisfied and the execution condition for the first PSCell is satisfied; and apply the second SCG configuration after determining that the execution condition for the PCell is satisfied and the execution condition for the first PSCell is not satisfied.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart/process illustrating a method performed by a UE for a conditional handover (CHO) in a multi-RAT dual connectivity (MR-DC) network, according to an example implementation of the present disclosure.

FIG. 2 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AL | Aggregation level |
| BFD | Beam Failure Detection |
| BWP | Bandwidth Part |
| CA | Carrier Aggregation |
| CC | Component Carrier |
| CCE | Control Chanel Element |
| CHO | Conditional Handover |
| CJT | Coherent Joint Transmission |
| CPA | Conditional PSCell Addition |
| CPAC | Conditional PSCell Addition and/or Change |
| CPC | Conditional PSCell Change |
| CRC | Cyclic Redundancy Check |
| C-RNTI | Cell-Radio Network Temporary Identifier |
| CS-RNTI | Configured Scheduling-Radio Network |
| | Temporary Identifier |
| CSS | Common Search Space |
| CSI | Channel State Information |
| DA | Dual Connectivity |
| DC | Dual Connectivity |
| DCI | Downlink Control Information |
| DL | Downlink |
| EN-DC | E-UTRA-NR Dual Connectivity |
| FDM | Frequency Division Multiplexing |
| GC-PDCCH | Group Common-Physical Downlink Control Channel |
| HARQ | Hybrid Automatic Repeat Request |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| MAC | Medium Access Control |
| MAC CE | MAC Control Element |
| MCG | Master Cell Group |
| MCS-C-RNTI | Modulation Coding Scheme-Cell-Radio |
| | Network Temporary |
| | Identifier |
| mTRP | Multiple Transmission Reception Point |
| MIB | Master Information Block |
| MIMO | Multiple-input Multiple-output |
| MN | Master Node |
| MR-DC | Multi-RAT Dual Connectivity |
| MSB | Most Significant Bit |
| NACK | Negative Acknowledgment |
| NDI | New Data Indicator |
| NE-DC | NR-E-UTRA Dual Connectivity |
| NGEN-DC | NG-RAN E-UTRA-NR Dual Connectivity |
| NR | New RAT/Radio |
| NR-DC | NR Dual Connectivity |
| NW | Network |
| PCI | Physical Cell ID |
| PCell | Primary Cell |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| PHY | Physical (layer) |
| PRACH | Physical Random Access Channel |
| PTAG | Primary Timing Advance Group |
| PUCCH | Physical Uplink Control Channel |
| PUSCH | Physical Uplink Shared Channel |
| RA | Random Access |
| RAN | Radio Access Network |
| RAR | Random Access Response |
| Rel | Release |
| RLF | Radio Link Failure |
| RMSI | Remaining Minimum System Information |
| RNTI | Radio Network Temporary Identifier |
| RRC | Radio Resource Control |
| RRM | Radio Resource Management |
| RS | Reference Signal |
| RSRP | Reference Signal Received Power |
| RV | Redundancy Version |
| SCell | Secondary Cell |
| SCG | Secondary Cell Group |
| SCS | Subcarrier Spacing |
| SDM | Spatial Division Multiplexing |
| SFN | Single Frequency Network |
| SI | System Information |
| SIB | System Information Block |
| SINR | Signal to Interference plus Noise Ratio |
| SN | Secondary Node |
| SpCell | Special Cell |
| SR | Scheduling Request |
| SRI | SRS resource indicator |
| SRS | Sounding Reference Signal |
| SSB | Synchronization Signal Block |
| STAG | Secondary Timing Advance Group |
| ST × MP | Simultaneous Transmission on Multiple Panels |
| SUL | Supplementary UL |
| TA | Timing Advance |
| TAG | Timing Advance Group |
| TB | Transport Block |
| TBS | Transport Block |
| TCI | Transmission Configuration Indication |
| TDM | Time Division Multiplexing |
| TPMI | Transmission Precoding Matrix Indicator |
| TR | Technical Report |
| TRP | Transmission Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WG | Working Group |
| WI | Working Item |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Descriptions of some selected terms in the present disclosure are provided as follows.

System information (SI): The SI may include master information block (MIB), system information block 1 (SIB1), and other SI (e.g., SIB3, SIB4, SIB5, and other SIB(s)). Minimum SI may include MIB and SIB1.

Primary Cell (PCell): The PCell may be an MCG cell that operates on the primary frequency. The UE may either perform the initial connection establishment procedure or initiate the connection re-establishment procedure in the MCG cell.

Primary Secondary Cell (PSCell): For DC operation, the PScell may be an SCG cell in which the UE may perform the random access when executing the Reconfiguration with Sync procedure.

Serving Cell: For a UE in the RRC_CONNECTED state and not configured with CA/DC, there may be only one serving cell including the PCell. For a UE in the RRC_CONNECTED state and configured with CA/DC, the term “serving cells” may be referred to as the set of cells including the SpCell(s) and all SCells.

Secondary Cell (SCell): For a UE configured with CA, a cell that provides additional radio resources on top of the SpCell.

Special Cell (SpCell): For DC operation, the term “SpCell” may be referred to as the PCell of the MCG or the PSCell of the SCG. Otherwise, the term “SpCell” may be referred to as the PCell.

Master Cell Group (MCG): In MR-DC, the MCG may include a group of serving cells associated with the master node (MN), including the SpCell (e.g., PCell) and optionally one or more SCells.

Master node (MN): In MR-DC, the MN may include the radio access node that provides the control plane connection to the core network. The MN may include a master eNB (e.g., in EN-DC), a master ng-eNB (e.g., in NGEN-DC), or a master gNB (e.g., in NR-DC and NE-DC).

Secondary Cell Group (SCG): In MR-DC, the SCG may include a group of serving cells associated with the secondary node, including the SpCell (e.g., PSCell) and optionally one or more SCells.

Secondary node (SN): In MR-DC, the SN may include the radio access node that does not provide the control plane connection to the core network, but provides additional resources to the UE. The SN may include an en-gNB (e.g., in EN-DC), a secondary ng-eNB (e.g., in NE-DC), or a secondary gNB (e.g., in NR-DC and NGEN-DC).

Complete configuration: The complete configuration may include an RRC configuration that a UE may directly apply for the execution of mobility procedure.

Reference configuration: The reference configuration may include an RRC configuration that is common to one or multiple delta configurations. A UE may combine the delta configuration and the associated reference configuration to obtain a complete configuration.

Delta configuration: The delta configuration may include an RRC configuration that a UE may combine with the associated reference configuration to obtain a complete configuration.

The terms “network (NW),” “cell,” “camped cell,” “serving cell,” “base station,” “gNB,” “eNB,” and “ng-eNB” may be used interchangeably. In some implementations, some of these items may include the same network entity.

The RAT may include NR, LTE, E-UTRA connected to 5GC, LTE connected to 5GC, E-UTRA connected to EPC, and LTE connected to EPC. The methods provided in the present disclosure may be applied for UEs in public networks or in private network (e.g., NPN (non-public network, SNPN (standalone NPN), PNI-NPN (public network integrated NPN)).

The methods provided in the present disclosure may be used for licensed frequency and/or unlicensed frequency. In addition, the conditional configuration selection provided in the present disclosure may be applied for the cases that a UE experiences a radio link failure (RLF) when the UE is configured with multiple conditional configurations.

Dedicated signaling may include RRC message(s). For example, the RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Re-establishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message.

The methods provided in the present disclosure may be applied to the RRC_CONNECTED UE, RRC_INACTIVE UE, and RRC_IDLE UE. The source cell may include a suitable cell or an acceptable cell.

A suitable cell may include a cell on which a UE may camp. The UE may determine that a cell is a suitable cell if the following conditions (1) and (2) are fulfilled: (1) The cell is part of either the selected PLMN or the registered PLMN or PLMN of the Equivalent PLMN list, and (2) The cell criteria of the cell are fulfilled. Furthermore, based on the latest information provided by NAS, the suitable cell may not be barred. The suitable cell may be part of at least one TA that is not part of the list of “Forbidden Tracking Areas,” which belongs to a PLMN that fulfils the condition (1).

An acceptable cell may include a cell on which the UE may camp and obtain limited services (e.g., originate emergency calls and receive ETWS and CMAS notifications). Such a cell may fulfil the following conditions (1) and (2), which are the minimum set of requirements to initiate an emergency call and to receive the ETWS and CMAS notifications in an NR network: (1) The cell is not barred and (2) The cell selection criteria are fulfilled.

The serving cell may include a PCell, an SCell, or a PSCell. The term “source node” may be referred to as a source MN, a source PCell, a source PSCell, or a source gNB. The target cell may include a PCell, an SCell, or a PSCell. The system information may be associated with the serving cell and/or the target cell.

The term “CPAC” may be referred to as the CPA, the CPC, or both the CPA and CPC. The term “source node” may be referred to as the source PCell, the source SCell, the source PSCell, the source MN, the source SN, and/or the source gNB. The term “candidate target MN” may be referred to as the MN associated with the candidate target PCells. The term “candidate target SN” may be referred to as the SN associated with the candidate target PSCells.

The CHO-only configuration may include a configuration and/or an IE that includes a candidate target PCell, execution condition(s) for the candidate target PCell, an MCG configuration for the candidate target PCell, without any execution condition for any PSCell, and without any SCG configuration for any PSCell.

The CHO with SCG configuration may include a configuration and/or an IE that includes a candidate target PCell, the associated PSCell, execution condition(s) for the candidate target PCell, an MCG configuration for the candidate target PCell, an SCG configuration for the associated PSCell, and without any execution condition for any PSCell.

The CHO with CPAC configuration may include a configuration and/or an IE that includes a candidate target PCell, the associated candidate target PSCell, execution condition(s) for the candidate target PCell, execution condition(s) for the candidate target PSCell, an MCG configuration for the candidate target PCell, and an SCG configuration for the associated candidate target PSCell.

An RRC configuration may include a delta configuration if at least one of the MCG configuration and the SCG configuration is a delta configuration. A reference configuration and/or a delta configuration may be an empty configuration. A reference configuration and/or a delta configuration may be a complete configuration. A condition may be determined to be satisfied if the configured measurement event (e.g., the RSRP value of the target cell is higher than a threshold (e.g., the RRC configured RSRP value)) holds for a configured time-to-trigger duration.

In wireless cellular networks, the mobile devices (e.g., the UE(s)) may move from a cell to other cell due to their mobility. When a mobile device moves from a serving cell to a neighbor cell, a mobility event may occur (e.g., the quality of signal received from the source cell falls below a threshold for a period). Then, a handover procedure may be needed to ensure that the mobile device can continue the ongoing service in the neighbor cell. The handover procedure may be triggered by the Layer 3 (L3) measurements and may be completed via the RRC signaling.

To further enhance the robustness of the handover procedure, the conditional handover (CHO) was proposed to ensure that a mobile device is configured with a configuration of the target cell in advance (e.g., when the signal quality, such as the RSRP, RSRQ, RSSI, SINR, between the mobile device and the source cell is still stable).

There may be an existing regular handover procedure for the Multi-RAT Dual Connectivity (MR-DC) (e.g., the RRC Reconfiguration messages configures the change of the PCell and the PSCell and the addition/release of the SCells). However, the CHO and the MR-DC cannot be configured simultaneously based on the current 3GPP technical specification. The restriction may limit the usefulness of the CHO feature when the MR-DC is configured. As a result, it may be desirable to investigate how to specify the simultaneous configuration of the CHO and the MR-DC to enhance the mobility robustness.

It may be preferable to specify the simultaneous configuration of the CHO and the MR-DC. However, only specifying the simultaneous configuration of the CHO and the MR-DC is not sufficient to optimize the MR-DC mobility since the signal quality of the conditionally configured PSCell may not be the best when the mobile device accesses to the target PCell. In such cases, the throughput of the mobile device may be influenced. As a result, the CHO with Conditional PSCell Addition and/or Change (CPAC) may be considered to be an enhancement.

The CHO with CPAC may involve the CHO and CPAC Configuration Step, CHO and CPAC Evaluation Step, and CHO and CPAC Execution Step. However, the preparation, the configuration, and the execution procedures are not specified in detail. For example, a UE may encounter a case that includes multiple conditional configurations the execution conditions of which are satisfied simultaneously. In the present disclosure, the term “satisfied conditional configuration” may be referred to as such conditional configurations. In the present disclosure, we aim to study some CHO with CPAC cases that include the preparation for CHO with CPAC, the configuration of CHO with CPAC, the selection of conditional configurations when a UE comes up with multiple satisfied conditional configurations, and the RLF handling case.

The CHO including the target MCG and the candidate SCGs for the Conditional PSCell Change (CPC)/Conditional PSCell Addition (CPA) in the NR-DC may be referred to as, but not limited to, the CHO with CPAC. In the present disclosure, “the CHO including the target MCG and candidate SCGs for the CPC/CPA in the NR-DC” and “the CHO with CPAC” may be used interchangeably.

A network may include multiple cells, and a UE may support the MR-DC configuration. That is, the UE may receive the service from at least two radio access network (RAN) nodes (e.g., a master node (MN) including MCG and at least one secondary node (SN) including SCG). In the present disclosure, the terms “MN” and “master gNB” may be used interchangeably, and the terms “SN” and “secondary gNB” may be used interchangeably. The UE may be equipped with multiple receivers and transmitters, and the UE may be capable of supporting the MR-DC dedicated configurations. The network having the information regarding the UE is capable of supporting the MR-DC may configure the UE with the MR-DC configuration (e.g., the SCG configuration). The MR-DC configuration (e.g., the SCG configuration) may be encapsulated in an RRC Reconfiguration message and transmitted from the serving gNB/cell to the UE. The UE may operate with the MR-DC configuration if the MR-DC is configured by the network to the UE. The UE may not operate with the MR-DC configuration if the MR-DC is not configured by the network to the UE.

If the UE is configured and operated with the MR-DC, the network may utilize radio resources provided by two distinct schedulers that are located in two different RAN nodes. The UE may maintain the control and user plane connection to the PCell in the MCG and to the PSCell in the SCG. For user plane, from the perspective of the UE, there may be three bearer types including the MCG bearer, the SCG bearer, and the split bearer. From the perspective of the network, each bearer may be terminated either in the MN or in the SN. In the present disclosure, the term “source node” may be referred to as the source MN, the source SN, the source gNB, the source PCell, and/or the source PSCell.

In some implementations, the source node may decide to initiate the CHO with CPAC. The source node may determine a list of target PCells based on the measurement report received from the UE via the RRC signaling. The source node (e.g., the source MN) may transmit an XnAP message (e.g., Message 1) to the MNs associated with the candidate target PCells. In the present disclosure, the term “candidate target MN” may be referred to as the MN associated with one or more candidate target PCells. In some implementations, the candidate target MN may determine the candidate target PCells and the associated PSCells, and may prepare the radio resource configuration for each candidate target PCell. The candidate target MN may transmit an XnAP message (e.g., Message 2) to the SNs associated with the candidate target PSCells. In the present disclosure, the term “candidate target SN” may be referred to as the SN associated with one or more candidate target PSCells. The candidate target SN may determine the candidate target PSCells, and may prepare the radio resource configuration for each candidate target PSCell. The candidate target SN may then transmit an XnAP message (e.g., Message 3) to the candidate target MN. Upon receiving the messages from all the associated candidate target SNs, the candidate target MN may transmit an XnAP message (e.g., Message 4) to the source node (e.g., the source MN).

In some implementations, the measurement report may include one or multiple measurement result IEs. In some implementations, a measurement result IE may include a measurement identity that is associated with a cell (e.g., the source PCell, the source SCell, the source PSCell, the candidate target PCell, the candidate target PSCell, or any other cells) with a reporting configuration (e.g., the RSRP, the RSSI, the SINR, or the RSRQ). In some implementations, a measurement result IE may include a measurement quantity IE indicating the measured quantity associated with the measurement identity.

In some implementations, the Message 1 from the source node (e.g., the source MN) to the candidate target MN may include the measurement result of the UE (e.g., the full content or the partial content in the measurement report sent by the UE to the source node), the recommended PCell list (e.g., including the PCell IDs identifying the recommended PCells), the current MCG configuration of the UE, and/or the current SCG configuration of the UE.

In some implementations, the Message 1 may further include an indication indicating whether the current MCG configuration is a reference configuration or a complete configuration. In some implementations, the Message 1 may further include an indication indicating whether the current SCG configuration is a reference configuration or a complete configuration. In some implementations, the Message 1 may further include an indication indicating whether both the current MCG and SCG configurations are the reference configurations or the complete configurations. In some implementations, the Message 1 may further include an indication indicating that the preparation is for the CHO with CPAC procedure. In some implementations, the Message 1 may further include an indication indicating whether the replied configurations in the Message 4 include at least an MCG-only configuration and/or an MCG with SCG configuration without execution conditions. In some implementations, the Message 1 may further include an indication indicating whether the replied configurations in the Message 4 are the delta configurations or the complete configurations.

In some implementations, the Message 2 from the candidate target MN to the candidate target SN may include the measurement results of the cells associated with the SN (e.g., the candidate target SN), the recommended PSCell list (e.g., including the PSCell IDs identifying the recommended PSCells), the current MCG configuration of the UE, the current SCG configuration of the UE, and/or the MCG configuration prepared for the candidate PCell.

In some implementations, the Message 2 may further include a PCell ID identifying the candidate target PCell for which the SN may prepare the PSCell(s) and the SCG configuration(s). In some implementations, the Message 2 may further include an indication indicating whether the current MCG configuration is a reference configuration or a complete configuration. In some implementations, the Message 2 may further include an indication indicating whether the current SCG configuration is a reference configuration or a complete configuration. In some implementations, the Message 2 may further include an indication indicating whether both the current MCG and SCG configurations are the reference configurations or the complete configurations.

In some implementations, the Message 2 may further include an indication indicating whether the prepared MCG configuration is a reference configuration or a complete configuration. In some implementations, the Message 2 may further include an indication indicating that the preparation is for the CHO with CPAC procedure. In some implementations, the Message 2 may further include an indication indicating whether the replied configurations in the Message 3 are the delta configurations or the complete configurations. In some implementations, the Message 3 from the candidate target SN to the candidate target MN may include, for each PCell, the prepared PSCell list and/or the corresponding SCG configurations. In some implementations, the Message 3 may further include an indication indicating that the configurations in the Message 3 are the delta configurations or the complete configurations.

In some implementations, the Message 4 from the candidate target MN to the source node (e.g., the source MN) may include the prepared PCell list (e.g., a list of PCell IDs identifying the prepared PCells), the prepared PSCell list (e.g., a list of PSCell IDs identifying the prepared PSCells) for each prepared PCell, the prepared MCG and SCG configurations for each PCell-PSCell pair, and the execution conditions for the PSCell for each PCell-PSCell pair. In some implementations, the Message 4 may further include an indication indicating whether each of the prepared MCG and SCG configurations (e.g., a prepared MCG and SCG configuration corresponding to a pair of prepared PCell and a prepared PSCell) is a delta configuration or a complete configuration.

In some implementations, the source node (e.g., the source MN) may decide to initiate the CHO procedure. The source node (e.g., the source MN) may determine a list of recommended target PCells based on the measurement report received form the UE via the RRC signaling. The source node may transmit an XnAP message (e.g., Message 1) to the candidate target MNs. In some implementations, the candidate target MN may decide to initiate the CHO with CPAC procedure, determine the candidate target PCells based on the measurement report and the recommendations received from the source node (e.g., the source MN), and prepare the radio resource configuration for each of the candidate target PCells of the leading/associated candidate target MN. For each prepared candidate target PCell, the candidate target MN may recommend one or more candidate target PSCells and transmit an XnAP message (e.g., Message 2) to the candidate target SNs.

The candidate target SN may determine the candidate target PSCells and prepare the radio resource configuration for each of the candidate target PSCells of the leading/associated candidate target SN. The candidate target SN may then transmit an XnAP message (e.g., Message 3) to the candidate target MN. Upon receiving the messages from all the associated candidate target SNs, the candidate target MN may transmit an XnAP message (e.g., Message 4) to the source node. A candidate target MN may lead (or involve or be associated with) the corresponding candidate target PCells. A candidate target SN may lead (or involve or be associated with) the corresponding candidate target PSCells.

In some implementations, before the Message 1 is transmitted, the source MN may transmit an XnAP message (e.g., Message A) to the source SN. Upon receiving the Message A, the source SN may reply an XnAP message (e.g., Message B) to the source MN. In some implementations, the Message A may include an indication field requesting the current SCG configuration, and/or an indication field indicating whether the replied SCG configuration is a complete configuration or a delta configuration. In some implementations, the Message B may include the current SCG configuration. In some implementations, the Message B may include an indication field indicating whether the SCG configuration is a complete configuration or a delta configuration.

In some implementations, the Message 1 from the source node to the candidate target MN may include the measurement result of the UE, the recommended PCell list (e.g., including a list of PCell IDs identifying the PCells), the current MCG configuration of the UE, and/or the current SCG configuration of the UE. In some implementations, the Message 1 may further include an indication indicating whether the current MCG configuration is a reference configuration or a complete configuration. In some implementations, the Message 1 may further include an indication indicating whether the current SCG configuration is a reference configuration or a complete configuration.

In some implementations, the Message 1 may further include an indication indicating whether both the current MCG and SCG configurations are the reference configurations or the complete configurations. In some implementations, the Message 1 may further include an indication indicating that the preparation is for the CHO procedure. In some implementations, the Message 1 may further include an indication indicating whether the replied configurations in the Message 4 are the delta configurations or the complete configurations.

In some implementations, the Message 2 from the candidate target MN to the candidate target SN may include the measurement results of cells associated with the candidate target SN, the recommended PSCell list (e.g., including the list of PSCell IDs identifying the PSCells), the current MCG configuration of the UE, the current SCG configuration of the UE, and/or the MCG configuration prepared for the candidate PCell.

In some implementations, the Message 2 may further include a PCell ID indicating the candidate target PCell for which the SN may prepare the PSCell(s) and SCG configuration(s). In some implementations, the Message 2 may further include an indication indicating whether the current MCG configuration is a reference configuration or a complete configuration. In some implementations, the Message 2 may further include an indication indicating whether the current SCG configuration is a reference configuration or a complete configuration. In some implementations, the Message 2 may further include an indication indicating whether both the current MCG and SCG configurations are the reference configurations or the complete configurations.

In some implementations, the Message 2 may further include an indication indicating whether the prepared MCG configuration is a reference configuration or a complete configuration. In some implementations, the Message 2 may further include an indication indicating that the preparation is for the CHO with CPAC procedure. In some implementations, the Message 2 may further include an indication indicating whether the replied configurations in the Message 3 are the delta configurations or the complete configurations. In some implementations, the candidate target MN may include the information included in the Message 2 and/or partial information included in the received Message 1. In some implementations, the partial information included in the received Message 1 may also be included in the Message 2. The candidate target MN may transmit the Message 2 to the candidate target SN.

In some implementations, the Message 3 from the candidate target SN to the candidate target MN may include, for each PCell, the prepared PSCell list and/or the corresponding SCG configurations. In some implementations, the Message 3 may further include an indication indicating that the configurations are the delta configurations or the complete configurations.

In some implementations, the Message 4 from the candidate target MN to the source node (e.g., the source MN) may include the prepared PCell list (e.g., a list of PCell IDs identifying the prepared PCells), the prepared PSCell list (e.g., a list of PSCell IDs identifying the prepared PSCells) for each prepared PCell, the prepared MCG and SCG configurations for each PCell-PSCell pair, and the execution conditions for the PSCell for each PCell-PSCell pair. In some implementations, the Message 4 may further include an indication indicating whether the prepared MCG and SCG configurations are the delta configurations or the complete configurations.

In some implementations, the source node may transmit the information of the CHO with CPAC to the UE via the RRC signaling. The RRC signaling may include one or multiple CHO-only configurations, one or multiple CHO with SCG configurations, one or multiple CHO with CPAC configurations, one or multiple CHO with CPA configurations, and/or one or multiple CHO with CPC configurations. In some implementations, the source node may further transmit the prioritization instruction to the UE via the RRC signaling.

In some implementations, the CHO-only configuration may include a conditional configuration ID, an MCG configuration, and execution condition(s), without any SCG configuration.

In some implementations, the CHO configuration may include a conditional configuration ID, an MCG configuration, execution condition(s), and an SCG configuration. The SCG configuration may be optional. If the SCG configuration is absent in the CHO configuration, the CHO configuration may be the CHO-only configuration. If the SCG configuration is not absent and the execution condition for any PSCell are not included in the execution condition(s), the CHO configuration may be the CHO with SCG configuration.

In some implementations, the CHO with SCG configuration may include a conditional configuration ID, an MCG configuration, an SCG configuration, and execution condition(s) for the candidate target PCell(s), without any execution condition for any PSCell. Each candidate target PCell (e.g., identified by a PCell ID) may correspond to an execution condition. All candidate target PCells (e.g., identified by PCell IDs) may correspond to an execution condition.

In some implementations, the CHO with CPAC configuration may include a conditional configuration ID, an MCG configuration, an SCG configuration, execution condition(s) for the candidate target PCell(s), and execution condition(s) for the associated candidate target PSCell(s). Each candidate target PCell (e.g., identified by a PCell ID) may correspond to an execution condition. All candidate target PCells (e.g., identified by the PCell IDs) may correspond to an execution condition. Each candidate target PSCell (e.g., identified by a PSCell ID) may correspond to an execution condition. All candidate target PSCells (e.g., identified by the PSCell IDs) may correspond to an execution condition.

In some implementations, one or multiple reference configurations may be pre-configured before the UE receives the CHO with CPAC configurations. In some implementations, a reference configuration may include an MCG configuration and/or an SCG configuration. In some implementations, a reference configuration may include a reference configuration ID. In some implementations, a reference configuration may be common to all the CHO with CPAC configurations if all the CHO with CPAC configurations are configured in delta form. In some implementations, a reference configuration may be common to the CHO with CPAC configurations associated with the same PCell if the CHO with CPAC configurations associated with the same PCell are configured in delta form.

In some implementations, a reference configuration may be common to the CHO with CPAC configurations associated with the same candidate target SN if the CHO with CPAC configurations associated with the same candidate target SN are configured in delta form. In some implementations, after the UE is pre-configured with the reference configuration and after the UE is configured with the CHO with CPAC configurations, the source node may configure the UE with the association between the pre-configured reference configuration and the CHO with CPAC configurations. In some implementations, the association may include a list of pairs including a conditional configuration ID and a reference configuration ID. In some implementations, the source node may configure an indication indicating that the UE may use the current MCG configuration and/or the current SCG configuration as the reference configuration.

In some implementations, the CHO with CPAC configuration may include an indication indicating whether the MCG configuration is a delta configuration or a complete configuration. For example, if the indication indicates “1,” “delta,” or be present, the MCG configuration may be a delta configuration. If the indication indicates “0,” “complete,” or be absent, the MCG configuration may be a complete configuration.

In some implementations, if the reference configuration of the MCG configuration is pre-configured before the UE receives the configuration of the CHO with CPAC configurations, the MCG configuration included in the CHO with CAPC configuration may be a delta configuration. Otherwise, the MCG configuration included in the CHO with CAPC configuration may be a complete configuration.

In some implementations, the CHO with CPAC configuration may include an indication indicating whether the SCG configuration is a delta configuration or a complete configuration. For example, if the indication indicates “1,” “delta,” or be present, the SCG configuration may be a delta configuration. If the indication indicates “0,” “complete,” or be absent, the SCG configuration may be a complete configuration.

In some implementations, if the reference configuration of the SCG configuration is pre-configured before the UE receives the configuration of the CHO with CPAC configurations, the SCG configuration included in the CHO with CAPC configuration may be a delta configuration. Otherwise, the SCG configuration included in the CHO with CAPC configuration may be a complete configuration.

In some implementations, the CHO with CPAC configuration may include an indication indicating whether both the MCG and SCG configurations are the delta configurations or the complete configurations. For example, if the indication indicates “1,” “delta,” or be present, both the MCG configuration and SCG configuration may be the delta configurations. If the indication indicates “0,” “complete,” or be absent, both the MCG configuration and SCG configuration may be the complete configurations.

In some implementations, if the reference configuration of the MCG configuration and the SCG configuration are pre-configured before the UE receives the configuration of the CHO with CPAC configurations, the MCG configuration and the SCG configuration included in the CHO with CAPC configuration may be a delta configuration. Otherwise, the MCG configuration and the SCG configuration included in the CHO with CAPC configuration may be a complete configuration.

In some implementations, the RRC signaling for the prioritization instruction may include a cross-release prioritization IE for prioritizing the CHO-only configuration, the CHO with SCG configuration, and the CHO with CPAC configuration when more than one of them (e.g., the execution condition for the CHO-only configuration, the execution condition for the CHO with SCG configuration, the execution condition for the CHO with CPAC configuration) are determined to be satisfied simultaneously. In some implementations, the RRC signaling for the prioritization instruction may further include a specific intra-release prioritization IE and/or a general intra-release prioritization IE for prioritizing the CHO with CPAC configurations when more than one of them (e.g., the execution condition for the CHO-only configuration, the execution condition for the CHO with SCG configuration, the execution condition for the CHO with CPAC configuration) are determined to be satisfied simultaneously.

In some implementations, the cross-release prioritization IE may include the enumerated format and have one of the values in the set {‘CRITERIA_1’, ‘CRITERIA_2’, ‘CRITERIA 3’}. In some implementations, the specific intra-release prioritization IE may include a list of conditional configuration IDs. In some implementations, the general intra-release prioritization IE may include the enumerated format and have one of the values in the set {‘HOLDING_TIME’, ‘CURRENT_QUALITY’}.

In some implementations, upon receiving the RRC signaling associated with the CHO-only configuration(s), the CHO with SCG configuration(s), the CHO with CPAC configuration(s), the pre-configuration reference configuration(s), and/or the prioritization instruction(s), the UE may store and apply a part of the configuration(s).

In some implementations, if the UE receives the pre-configured reference configuration(s), the UE may store the reference configurations. In some implementations, if the UE receives the association between the reference configurations and the CHO with CPAC configurations, the UE may store the association. The reference configuration may be applied to the CHO-only configuration(s), the CHO with SCG configuration(s), and/or the CHO with CPAC configuration(s).

In some implementations, if the UE receives prioritization instruction(s) (e.g., via RRC signaling), the UE may store the prioritization instruction(s). In some implementations, upon receiving a CHO-only configuration, the UE may store the CHO-only configuration and start evaluating the execution condition(s) in the CHO-only configuration (e.g., start determining whether the execution condition(s) in the CHO-only configuration is satisfied). In some implementations, upon receiving a CHO with SCG configuration, the UE may store the CHO with SCG configuration and start evaluating the execution condition(s) in the CHO with SCG configuration (e.g., start determining whether the execution condition(s) in the CHO with SCG configuration is satisfied).

In some implementations, upon receiving a CHO with CPAC configuration, the UE may directly store the CHO with CPAC configuration, and the UE may start evaluating the execution condition(s) for PCell and the execution condition(s) for PSCell in the CHO with CPAC configuration (e.g., start determining whether the execution condition(s) for PCell and the execution condition(s) for PSCell in the CHO with CPAC configuration are satisfied). In some implementations, upon receiving a CHO with CPAC configuration, the UE may ignore the CHO with CPAC configuration and may not store the CHO with CPAC configuration.

In some implementations, upon receiving a CHO-only, a CHO with SCG, or a CHO with CPAC configuration, the UE may check the conditional configuration ID included in the configuration. In some implementations, if the conditional configuration ID matches one of the stored conditional configurations, the UE may release the stored conditional configuration the conditional configuration ID of which matches that of the received conditional configuration.

In some implementations, upon receiving a CHO with CPAC configuration, the UE may check whether the CHO with CPAC configuration is a delta configuration or a complete configuration. In some implementations, if the UE determines that the CHO with CPAC configuration is a complete configuration, the UE may directly store the CHO with CPAC configuration, and the UE may start evaluating the execution condition(s) for PCell and the execution condition(s) for PSCell in the CHO with CPAC configuration (e.g., start determining whether the execution condition(s) for PCell and the execution condition(s) for PSCell in the CHO with CPAC configuration are satisfied).

In some implementations, the UE may directly determine the CHO with CPAC configuration is a complete configuration upon receiving the CHO with CPAC configuration. In some implementations, if the UE does not receive any reference configuration from the source node (e.g., the source MN), the UE may directly determine the CHO with CPAC configuration is a complete configuration upon receiving the CHO with CPAC configuration. In some implementations, the UE may determine that the CHO with CPAC configuration is a complete configuration if an IE in the CHO with CPAC configuration indicates that the MCG configuration in the CHO with CPAC configuration is a complete configuration and another IE in the CHO with CPAC configuration indicates that the SCG configuration in the CHO with CPAC configuration is also a complete configuration.

In some implementations, the UE may determine that the CHO with CPAC configuration is a complete configuration if an IE in the CHO with CPAC configuration indicates that both the MCG and the SCG configurations in the CHO with CPAC configuration are complete configurations. In some implementations, the UE may determine that the CHO with CPAC configuration is a complete configuration if, in another RRC signaling, an IE indicates that the MCG configuration in the CHO with CPAC configuration is a complete configuration and another IE indicates that the SCG configuration in the CHO with CPAC configuration is a complete configuration. In some implementations, the UE may determine that the CHO with CPAC configuration is a complete configuration if, in another RRC signaling, an IE indicates that both the MCG configuration in the CHO with CPAC configurations are complete configurations.

In some implementations, upon receiving a CHO with CPAC configuration, the UE may check whether the CHO with CPAC configuration is a delta configuration or a complete configuration. In some implementations, if the UE determines that the CHO with CPAC configuration is a delta configuration, the UE may directly store the CHO with CPAC configuration, and the UE may start evaluating the execution condition(s) for PCell and the execution condition(s) for PSCell in the CHO with CPAC configuration (e.g., start determining whether the execution condition(s) for PCell and the execution condition(s) for PSCell in the CHO with CPAC configuration are satisfied).

In some implementations, the UE may determine that the CHO with CPAC configuration is a delta configuration if an IE in the CHO with CPAC configuration indicates that the MCG configuration in the CHO with CPAC configuration is a delta configuration or another IE in the CHO with CPAC configuration indicates that the SCG configuration in the CHO with CPAC configuration is a delta configuration. In some implementations, the UE may determine that the CHO with CPAC configuration is a complete configuration if an IE in the CHO with CPAC configuration indicates that both the MCG and the SCG configurations in the CHO with CPAC configuration are delta configurations.

In some implementations, the UE may determine that the CHO with CPAC configuration is a complete configuration if, in another RRC signaling, an IE indicates that the MCG configuration in the CHO with CPAC configuration is a delta configuration or another IE indicates that the SCG configuration in the CHO with CPAC configuration is a delta configuration. In some implementations, the UE may determine that the CHO with CPAC configuration is a complete configuration if, in another RRC signaling, an IE indicates that both the MCG configuration in the CHO with CPAC configurations are delta configurations.

In some implementations, upon receiving a CHO with CPAC configuration, the UE may check whether the CHO with CPAC configuration is a delta configuration or a complete configuration. In some implementations, if the UE determines that the CHO with CPAC configuration is a delta configuration, the UE may combine the CHO with CPAC configuration with the stored reference configuration to obtain a complete configuration. In some implementations, the UE may store the obtained complete configuration, and the UE may start evaluating the execution condition(s) for PCell and the execution condition(s) for PSCell in the CHO with CPAC configuration (e.g., start determining whether the execution condition(s) for PCell and the execution condition(s) for PSCell in the CHO with CPAC configuration are satisfied).

In some implementations, the UE may determine that the CHO with CPAC configuration is a delta configuration if an IE in the CHO with CPAC configuration indicates that the MCG configuration in the CHO with CPAC configuration is a delta configuration or another IE in the CHO with CPAC configuration indicates that the SCG configuration in the CHO with CPAC configuration is a delta configuration.

In some implementations, the UE may determine that the CHO with CPAC configuration is a complete configuration if an IE in the CHO with CPAC configuration indicates that both the MCG and the SCG configurations in the CHO with CPAC configuration are delta configurations.

In some implementations, the UE may determine that the CHO with CPAC configuration is a complete configuration if, in another RRC signaling, an IE indicates that the MCG configuration in the CHO with CPAC configuration is a delta configuration or another IE indicates that the SCG configuration in the CHO with CPAC configuration is a delta configuration.

In some implementations, the UE may determine that the CHO with CPAC configuration is a complete configuration if, in another RRC signaling, an IE indicates that both the MCG configuration in the CHO with CPAC configurations are delta configurations.

In some implementations, if the UE is indicated by the source node (e.g., the source MN) that the current MCG and/or SCG configuration is used as the reference configuration, the UE may use the current MCG and/or SCG configuration as the reference configuration.

In some implementations, if the UE is not indicated by the source node (e.g., the source MN) that the current MCG and/or SCG configuration is used as the reference configuration, and if the UE does not receive any reference configuration from the source node, the UE may still use the current MCG and/or SCG configuration as the reference configuration.

In some implementations, if the UE receives a reference configuration, upon receiving a CHO with CPAC configuration, the UE may combine the CHO with CPAC configuration with the stored reference configuration to obtain a complete CHO with CPAC configuration. In some implementations, the UE may store the complete CHO with CPAC configuration.

In some implementations, if the UE receives multiple reference configurations and the association between the reference configurations and the CHO with CPAC configurations, upon receiving a CHO with CPAC configuration, the UE may combine the received CHO with CPAC configuration with the corresponding stored reference configuration to obtain a complete CHO with CPAC configuration. Then, the UE may store the complete CHO with CPAC configuration. In some implementations, the UE may search the stored association for the conditional configuration ID corresponding to the received CHO with CPAC. The UE may determine that the reference configuration the ID of which appears along with the searched conditional configuration ID in the same pair is the reference configuration associated with the CHO with CPAC configuration.

In some implementations, if the UE receives multiple reference configurations and the CHO with CPAC configurations, upon receiving the association between the reference configurations and the CHO with CPAC configurations, for each received CHO with CPAC configurations, the UE may combine the received CHO with CPAC configuration with the corresponding stored reference configuration to obtain a complete CHO with CPAC configuration. Then, the UE may store the complete CHO with CPAC configuration. In some implementations, the UE may search the stored association for the conditional configuration ID corresponding to the received CHO with CPAC. The UE may determine that the reference configuration the ID of which appears along with the searched conditional configuration ID in the same pair is the reference configuration associated with the CHO with CPAC configuration.

In some implementations, if an IE in the received CHO with CPAC configuration indicates that the MCG configuration is a delta configuration, the UE may combine the MCG configuration in the received CHO with CPAC configuration with the MCG configuration in the associated reference configuration to obtain a complete MCG configuration for the complete CHO with CPAC configuration.

In some implementations, if an IE in the received CHO with CPAC configuration indicates that the SCG configuration is a delta configuration, the UE may combine the SCG configuration in the received CHO with CPAC configuration with the SCG configuration in the associated reference configuration to obtain a complete SCG configuration for the complete CHO with CPAC configuration.

In some implementations, if an IE in the received CHO with CPAC configuration indicates that both the MCG and SCG configurations are delta configurations, the UE may combine the MCG configuration in the received CHO with CPAC configuration with the MCG configuration in the associated reference configuration to obtain a complete MCG configuration for the complete CHO with CPAC configuration, and the UE may combine the SCG configuration in the received CHO with CPAC configuration with the SCG configuration in the associated reference configuration to obtain a complete SCG configuration for the complete CHO with CPAC configuration.

In some implementations, after the UE combines the CHO with CPAC configuration with the associated reference configuration and obtains the complete configuration, the UE may change the IE indicating whether the configuration is a delta configuration or a complete configuration. For example, if the IE indicates that the MCG configuration is a delta configuration, the UE may change the IE to indicate that the MCG configuration is a complete configuration after the UE combines the CHO with CPAC configuration with the associated reference configuration and obtains the complete configuration. For example, if the IE indicates that the SCG configuration is a delta configuration, the UE may change the IE to indicate that the SCG configuration is a complete configuration after the UE combines the CHO with CPAC configuration with the associated reference configuration and obtains the complete configuration. For example, if the IE indicates that both the MCG and SCG configurations are delta configurations, the UE may change the IE to indicate that both the MCG and SCG configurations are complete configurations after the UE combines the CHO with CPAC configuration with the associated reference configuration and obtains the complete configuration. In some implementations, the UE may store the changed IE in the complete configuration.

In some implementations, if a UE configured with one or multiple CHO-only configurations, one or multiple CHO with SCG configurations, and/or one or multiple CHO with CPAC configurations, and multiple conditional configurations the execution condition(s) of which are determined to be satisfied simultaneously, the UE may select one of the conditional configurations the execution condition(s) of which are determined to be satisfied. Then, the UE may apply the selected configuration. In the present disclosure, the term “satisfied CHO-only configuration” may be referred to as the CHO-only configuration the execution condition(s) of which are satisfied. The term “satisfied CHO with SCG configuration” may be referred to as the CHO with SCG configuration the execution condition(s) of which are satisfied. The term “satisfied CHO with CPAC configuration” may be referred to as the CHO with a CPAC configuration the execution condition(s) of which are satisfied.

In some implementations, if the UE receives the prioritization instruction (e.g., the RRC signaling for the prioritization instruction including cross-release, general intra-release, and/or specific intra-release prioritization IE) from the network and stores the information in the RRC signaling for prioritization instruction, the UE may select the conditional configuration based on the prioritization instruction.

In some implementations, the UE may check whether there is any satisfied CHO with CPAC configurations. If there is at least one satisfied CHO with CPAC configuration, the UE may prioritize the at least one satisfied CHO with CPAC configuration over the others. In some implementations, if there is only one satisfied CHO with CPAC configuration, the UE may directly apply the conditional configuration of this satisfied CHO with CPAC configuration.

In some implementations, if there is more than one satisfied CHO with CPAC configuration, and if the UE has stored the specific intra-release prioritization IE, the UE may check the specific intra-release prioritization IE. In some implementations, starting from the first entry in the specific intra-release prioritization IE, the UE may check whether the conditional configuration ID of the satisfied CHO with CPAC configurations matches the conditional configuration ID indicated by the entry.

In some implementations, if there is a satisfied CHO with a CPAC configuration the conditional configuration ID of which matches the entry, the UE may select the satisfied CHO with CPAC configuration, and the UE may apply the conditional configuration of the selected CHO with CPAC configuration. In some implementations, the UE may stop checking the prioritization instruction and/or release a part, or all, of the prioritization instruction upon applying the selected CHO with CPAC configuration. In some implementations, if there is no satisfied CHO with CPAC configuration the conditional configuration ID of which matches the entry, the UE may check the next entry in the specific intra-release prioritization IE.

In some implementations, if there is more than one satisfied CHO with a CPAC configuration, and if the UE has not stored the specific intra-release prioritization IE, the UE may check the general intra-release prioritization IE. In some implementations, if the general intra-release prioritization IE indicates “HOLDING_TIME,” the UE may select the satisfied CHO with CPAC configuration the execution condition(s) of which are determined to be satisfied for the longest period of time, and the UE may apply the conditional configuration of the selected CHO with CPAC configuration. In some implementations, the UE may release a part, or all, of the prioritization instruction upon applying the selected CHO with CPAC configuration. In some implementations, if the general intra-release prioritization IE indicates “CURRENT_QUALITY,” the UE may select the satisfied CHO with CPAC configuration the measured RSRP/RSRQ/RSSI/SINR of which is the best, and the UE may apply the conditional configuration of the selected CHO with CPAC configuration. In some implementations, the UE may release a part, or all, of the prioritization instruction upon applying the selected CHO with CPAC configuration.

In some implementations, if the UE has stored the specific intra-release prioritization IE, and if none of the satisfied CHO with a CPAC configuration matches the entries in the specific intra-release prioritization IE, the UE may check the general intra-release prioritization IE. In some implementations, if the general intra-release prioritization IE indicates “HOLDING_TIME,” the UE may select the satisfied CHO with CPAC configuration the execution condition(s) of which are determined to be satisfied for the longest period of time, and the UE may apply the conditional configuration of the selected CHO with CPAC configuration. In some implementations, the UE may release a part, or all, of the prioritization instruction upon applying the selected CHO with CPAC configuration. In some implementations, if the general intra-release prioritization IE indicates “CURRENT_QUALITY,” the UE may select the satisfied CHO with CPAC configuration the measured RSRP/RSRQ/RSSI/SINR of which is the best, and the UE may apply the conditional configuration of the selected CHO with CPAC configuration. In some implementations, the UE may release a part, or all, of the prioritization instruction upon applying the selected CHO with CPAC configuration.

In some implementations, the UE may check whether there is any satisfied CHO with CPAC configurations. If there are no satisfied CHO with CPAC configurations, the UE may determine to select a conditional configuration among the satisfied CHO-only configuration and/or the satisfied CHO with SCG configuration. In some implementations, if the cross-release prioritization IE indicates “CRITERIA1,” the UE may select the CHO-only configuration and apply the conditional configuration of the selected CHO-only configuration. In some implementations, upon selecting the CHO-only configuration, the UE may release a part of or all of the prioritization instruction. In some implementations, if the cross-release prioritization IE indicates “CRITERIA2,” the UE may select the CHO with SCG configuration and apply the conditional configuration of the selected CHO with SCG configuration. In some implementations, the UE may release a part of or all of the prioritization instruction.

In some implementations, if the cross-release prioritization IE indicates “CRITERIA3,” the UE may check whether the CHO with SCG configuration is associated with the current PSCell and/or the current SCG. In some implementations, if the CHO with SCG configuration is associated with the current PSCell and/or the current SCG, the UE may select the CHO with SCG configuration and apply the conditional configuration of the selected CHO with SCG configuration. In some implementations, the UE may release a part of or all of the prioritization instruction. In some implementations, if the CHO with SCG configuration is not associated with the current PSCell and/or current SCG, the UE may select the CHO-only configuration and apply the conditional configuration of the selected CHO-only configuration. In some implementations, the UE may release a part of or all of the prioritization instruction.

In some implementations, if the UE does not receive the prioritization instruction from the network, the UE may select and apply the conditional configuration based on UE's implementation. In some implementations, the UE may check whether there is any satisfied CHO with CPAC configurations. If there are at least one satisfied CHO with CPAC configuration, the UE may prioritize the at least one satisfied CHO with CPAC configuration over the others. In some implementations, the UE may select the satisfied CHO with CPAC configuration associated with UE's serving PSCell, and the UE may apply the conditional configuration in the selected CHO with CPAC configuration. In some implementations, the UE may select the satisfied CHO with CPAC configuration the execution condition(s) of which are determined to be satisfied for the longest period of time, and the UE may apply the conditional configuration of the selected CHO with CPAC configuration. In some implementations, the UE may select the satisfied CHO with CPAC configuration the current RSRP/RSRQ/RSSI/SINR of which is the best, and the UE may apply the conditional configuration of the selected CHO with CPAC configuration.

In some implementations, the UE may check whether there is any satisfied CHO with CPAC configurations. If there is no satisfied CHO with CPAC configuration, the UE may determine to select a conditional configuration among the satisfied CHO-only configuration and/or the satisfied CHO with SCG configuration. In some implementations, the UE may select the CHO-only configuration, and the UE may apply the conditional configuration in the selected CHO-only configuration. In some implementations, the UE may select the CHO with SCG configuration, and the UE may apply the conditional configuration in the selected CHO with SCG configuration.

In some implementations, the UE may check whether the CHO with SCG configuration is associated with the source PSCell or the currently serving SCG. In some implementations, if the satisfied CHO with SCG configuration is associated with the source PSCell or the currently serving SCG, the UE may select the CHO with SCG configuration, and the UE may apply the conditional configuration in the selected CHO with SCG configuration. In some implementations, if the satisfied CHO with SCG configuration is not associated with the source PSCell or the currently serving SCG, the UE may select the CHO-only configuration, and the UE may apply the conditional configuration in the selected CHO-only configuration.

In some implementations, after the UE selects a satisfied conditional configuration, and before the UE applies the selected conditional configuration, if the UE determines that one or both of the MCG and SCG configurations in the stored conditional configuration is a delta configuration, the UE may combine the conditional configuration with a reference configuration.

In some implementations, if the UE stores a single reference configuration, the UE may apply the reference configuration. In some implementations, if the UE stores multiple reference configurations along with the association between reference configurations and the delta configurations, the UE may check the association and identify the reference configuration associated with the selected conditional configuration. Then, the UE may apply the associated reference configuration. In some implementations, if the UE does not store any reference configuration, the UE may use the current MCG and/or SCG configuration as the reference configuration.

In some implementations, if an IE associated with the conditional configuration indicates that the MCG configuration is a delta configuration, the UE may determine that the MCG configuration is a delta configuration. In some implementations, the UE may combine the MCG configuration in the selected conditional configuration with the MCG configuration in the associated reference configuration to obtain a complete MCG configuration for the complete conditional configuration.

In some implementations, if an IE associated with the conditional configuration indicates that the SCG configuration is a delta configuration, the UE may determine that the SCG configuration is a delta configuration. In some implementations, the UE may combine the SCG configuration in the selected conditional configuration with the SCG configuration in the associated reference configuration to obtain a complete SCG configuration for the complete conditional configuration.

In some implementations, if an IE associated with the conditional configuration indicates that both the MCG and the SCG configurations are delta configurations, the UE may determine that both the MCS and SCG configurations are delta configurations. In some implementations, the UE may combine the MCG configuration in the selected conditional configuration with the MCG configuration in the associated reference configuration to obtain a complete MCG configuration for the complete conditional configuration, and the UE may combine the SCG configuration in the selected conditional configuration with the SCG configuration in the associated reference configuration to obtain a complete SCG configuration for the complete conditional configuration.

In some implementations, if a UE is configured with the CHO with CPAC configurations, the UE may be configured by the source node (e.g., the source MN) that the UE is allowed to perform the CHO with CPAC once the UE declares RLF due to T310 timer expiry and the selected cell is a candidate target cell after the cell selection/reselection procedure. In the present disclosure, the term “attempt indication” may be referred to as the indication configured to the UE that indicates that the UE is allowed to perform the conditional configuration associated with the selected cell after RLF declaration.

In some implementations, the attempt indication may take an ENUMERATED format and have the value {‘TRUE’}. In some implementations, the attempt indication may take an ENUMERATED format and have one of the values in {′TRUE′, ‘FALSE’}. In some implementations, the UE may stop the condition evaluation on CHO with CPAC upon the UE declares the RLF due to T310 timer expiry. In some implementations, the UE may continue the condition evaluation on CHO with CPAC upon the UE declares the RLF due to T310 timer expiry. It should be noted that the UE's behavior regarding the continuation of condition evaluation may be up to UE's implementation or configured by the source node (e.g., the source MN). In some implementations, if the UE is configured with the attempt indication, and if there are one or multiple conditional configurations associated with the selected cell, the UE may select and apply one of the one or multiple conditional configurations associated with the selected cell.

In some implementations, if the UE continues evaluating the execution conditions on the CHO with CPAC configurations, and if one or more CHO with CPAC configurations are determined to be satisfied, the UE may select and apply one of the satisfied CHO with CPAC configurations which is associated with the selected cell. In some implementations, after declaring the RLF, the UE may determine that a CHO with CPAC configuration is satisfied if the execution condition(s) for both PCell and the PSCell are determined to be satisfied. In some implementations, after declaring the RLF, the UE may determine that a CHO with CPAC configuration is satisfied if the execution condition(s) for the PSCell is determined to be satisfied.

In some implementations, if the UE stops evaluating the execution conditions on the CHO with CPAC configurations, the UE may select and apply the CHO-only configuration or the CHO with SCG configuration associated with the selected cell. In some implementations, if the UE is configured with only a CHO-only configuration associated with the selected cell, the UE may directly apply the CHO-only configuration. In some implementations, if the UE is configured with only a CHO with SCG configuration associated with the selected cell, the UE may directly apply the CHO with SCG configuration. In some implementations, if the UE is configured with a CHO-only configuration and a CHO with SCG configuration associated with the selected cell, the UE may select between the CHO-only configuration and the CHO with SCG configuration, and apply the selected one of the CHO-only configuration and the CHO with SCG configuration. It should be noted that the UE's behavior regarding the selection may be up to UE's implementation or configured by the source node.

In some implementations, upon applying a stored CHO with CPAC configuration the MCG configuration of which includes a particular IE, such as the reconfiguration WithSync IE, the UE may start a timer (e.g., T304 timer) for the MCG configuration to monitor the access to the PCell. In some implementations, the UE may stop the timer if the UE successfully connects to the target PCell (e.g., upon the successful completion of the random access on the target PCell). In some implementations, if the timer expires, the UE may perform cell selection/reselection procedure.

In some implementations, the UE may stop the condition evaluation on the CHO with CPAC upon the UE declares the RLF due to T304 timer expiry. In some implementations, the UE may continue the condition evaluation on the CHO with CPAC upon the UE declares of the RLF due to T304 timer expiry. It should be noted that the UE's behavior regarding the continuation of condition evaluation may be up to UE's implementation or configured by the source node (e.g., the source MN). In some implementations, if the UE is configured with the attempt indication, and if there is one or multiple conditional configurations associated with the selected cell, the UE may select and apply one of the one or multiple conditional configurations associated with the selected cell.

In some implementations, if the UE continues evaluating the execution conditions on the CHO with CPAC configurations, and if one or more CHO with CPAC configurations are determined to be satisfied, the UE may select and apply one of the satisfied one or more CHO with CPAC configurations which is associated with the selected cell. In some implementations, after declaring the RLF, the UE may determine that a CHO with CPAC configuration is satisfied if the execution condition(s) for both the PCell and the PSCell are determined to be satisfied. In some implementations, after declaring the RLF, the UE may determine that a CHO with CPAC configuration is satisfied if the execution condition(s) for the PSCell is determined to be satisfied.

In some implementations, if the UE stops evaluating the execution conditions on the CHO with CPAC configurations, the UE may select and apply the CHO-only configuration or the CHO with SCG configuration associated with the selected cell. In some implementations, if the UE is configured with only a CHO-only configuration associated with the selected cell, the UE may directly apply that CHO-only configuration. In some implementations, if the UE is configured with only a CHO with SCG configuration associated with the selected cell, the UE may directly apply that CHO with SCG configuration. In some implementations, if the UE is configured with a CHO-only configuration and a CHO with SCG configuration associated with the selected cell, the UE may select between the CHO-only configuration and the CHO with SCG configuration and apply the selected one of the CHO-only configuration and the CHO with SCG configuration. It should be noted that the UE's behavior regarding the selection may be up to UE's implementation or configured by the source node (e.g., the source MN).

In some implementations, if a UE applies a CHO with CPAC configuration and has already successfully connected to the target PCell, and if the SCG configuration in the CHO with CPAC configuration includes a particular IE, such as the reconfiguration With Sync IE, the UE may start a timer (e.g., T304 timer) for the SCG configuration to monitor the access to the PSCell. In some implementations, the UE may stop the timer if the UE successfully connects to the target PSCell (e.g., upon the successful completion of the random access on the target PSCell).

In some implementations, if the timer expires, the UE may initiate the SCG failure information procedure and transmit an SCG failure indication to the accessed PCell. In some implementations, if the timer expires, the UE may check whether the CHO-only configuration and/or CHO with SCG configuration associated with the accessed PCell is stored.

In some implementations, if there is no any CHO-only configuration nor any CHO with SCG configuration associated with the accessed PCell, the UE may initiate an SCG failure information procedure and transmit an SCG failure indication to the accessed PCell.

In some implementations, if there is only a CHO-only configuration associated with the accessed PCell, the UE may apply the CHO-only configuration. In some implementations, the UE may send the RRC signaling to the accessed MN to indicate that the UE has changed the applied conditional configuration. In some implementations, to cancel the prepared radio resources in the SN, the accessed MN may initiate the SN release procedure to the candidate target SN which the UE has failed to access to.

In some implementations, the RRC signaling sent by the UE to the accessed MN may include an indication indicating the change of the applied conditional configuration. In some implementations, the RRC signaling sent by the UE to the accessed MN may include a cause of the change. In some implementations, the RRC signaling sent by the UE to the accessed MN may include the conditional configuration ID of the newly applied conditional configuration.

In some implementations, if there is only a CHO with SCG configuration associated with the accessed PCell, the UE may apply the CHO with SCG configuration. In some implementations, the UE may send the RRC signaling to the accessed MN to indicate that the UE has changed the applied conditional configuration. In some implementations, to cancel the prepared radio resources in the SN, the accessed MN may initiate the SN release procedure to the candidate target SN which UE has failed to access to.

In some implementations, the RRC signaling sent by the UE to the accessed MN may include an indication indicating the change of the applied conditional configuration. In some implementations, the RRC signaling sent by the UE to the accessed MN may include a cause of the change. In some implementations, the RRC signaling sent by the UE to the accessed MN may include the conditional configuration ID of the newly applied conditional configuration.

In some implementations, if there is both a CHO-only configuration and a CHO with SCG configuration associated with the accessed PCell, the UE may select and apply one of the conditional configurations. In some implementations, the UE may send the RRC signaling to the accessed MN to indicate that the UE has changed the applied conditional configuration. In some implementations, to cancel the prepared radio resources in the SN, the accessed MN may initiate the SN release procedure to the candidate target SN which UE has failed to access to.

In some implementations, the UE may select the conditional configuration based on the indication from the source node (e.g., the source MN). In some implementations, the UE may select the CHO-only configuration. In some implementations, the UE may select the CHO with SCG configuration. In some implementations, the UE may check whether the PSCell of the CHO with SCG configuration is the source PSCell. If the PSCell of the CHO with SCG configuration is the source PSCell, the UE may select the CHO with SCG configuration. If the PSCell of the CHO with SCG configuration is not the source PSCell, the UE may select the CHO-only configuration.

In some implementations, the RRC signaling sent by the UE to the accessed MN may include an indication indicating the change of the applied conditional configuration. In some implementations, the RRC signaling sent by the UE to the accessed MN may include a cause of the change. In some implementations, the RRC signaling sent by the UE to the accessed MN may include the conditional configuration ID of the newly applied conditional configuration.

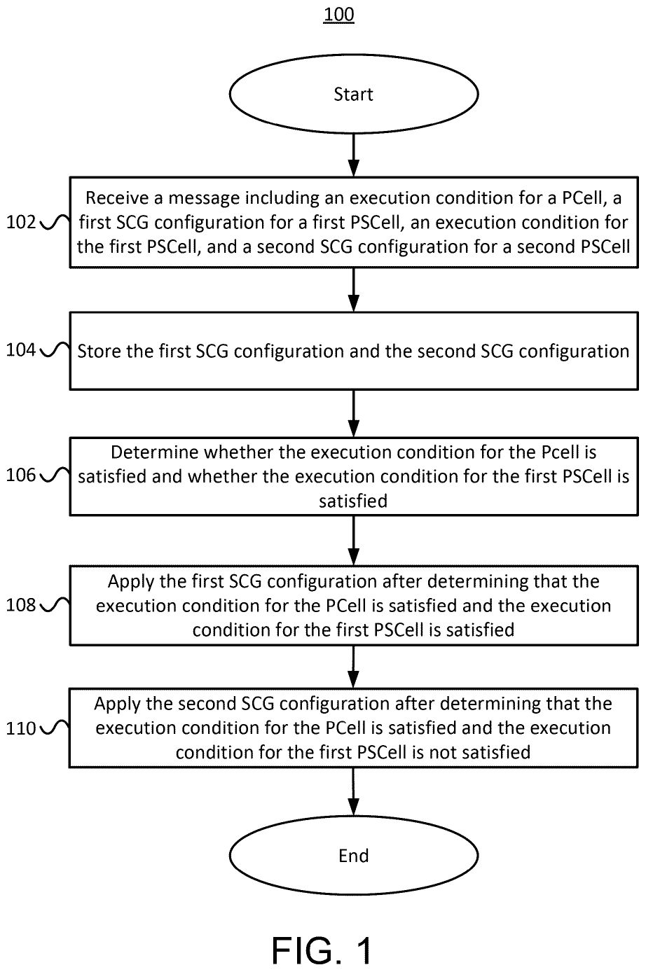

FIG. 1 is a flowchart/process 100 illustrating a method performed by a UE for a conditional handover (CHO) in a multi-RAT dual connectivity (MR-DC) network, according to an example implementation of the present disclosure.

Process 100 may start, in action 102, by the UE receiving a message that includes an execution condition for a primary cell (PCell), a first secondary cell group (SCG) configuration for a first primary secondary cell (PSCell), an execution condition for the first PSCell, and a second SCG configuration for a second PSCell. In some implementations, the message (e.g., the first SCG configuration and the second SCG configuration) may be received via radio resource control (RRC) signaling.

In action 104, the UE may store the first SCG configuration and the second SCG configuration.

In action 106, the UE may determine whether the execution condition for the PCell is satisfied and whether the execution condition for the first PSCell is satisfied.

In action 108, the UE may apply the first SCG configuration after determining that the execution condition for the PCell is satisfied and the execution condition for the first PSCell is satisfied. In some implementations, the UE may connect, based on the first SCG configuration, to the first PSCell after determining that the execution condition for the PCell is satisfied and the execution condition for the first PSCell is satisfied.

In action 110, the UE may apply the second SCG configuration after determining that the execution condition for the PCell is satisfied and the execution condition for the first PSCell is not satisfied. In some implementations, the UE may connect, based on the second SCG configuration, to the second PSCell after determining that the execution condition for the PCell is satisfied and the execution condition for the first PSCell is not satisfied.

The technical problem addressed by the present disclosure is how to effectively manage and optimize a conditional handover (CHO) in multi-RAT dual connectivity (MR-DC) environments. Specifically, the problem is to determine how a user equipment (UE) may dynamically and efficiently apply different secondary cell group (SCG) configurations based on the satisfaction of execution conditions for a primary cell (PCell) and a primary secondary cell (PSCell). Such a mechanism aims to ensure seamless connectivity and improved handover performance in complex MR-DC scenarios, where multiple SCG configurations may be available.

The method provided in the present disclosure significantly enhances the efficiency and reliability of the CHO in the MR-DC environments. By allowing the UE to dynamically store and manage multiple SCG configurations, the method ensures that the most appropriate configuration is applied based on the satisfaction of specific execution conditions for the PCell and the PSCell. This dynamic adaptability may lead to improved handover performance, reducing the likelihood of handover failures and ensuring seamless connectivity.

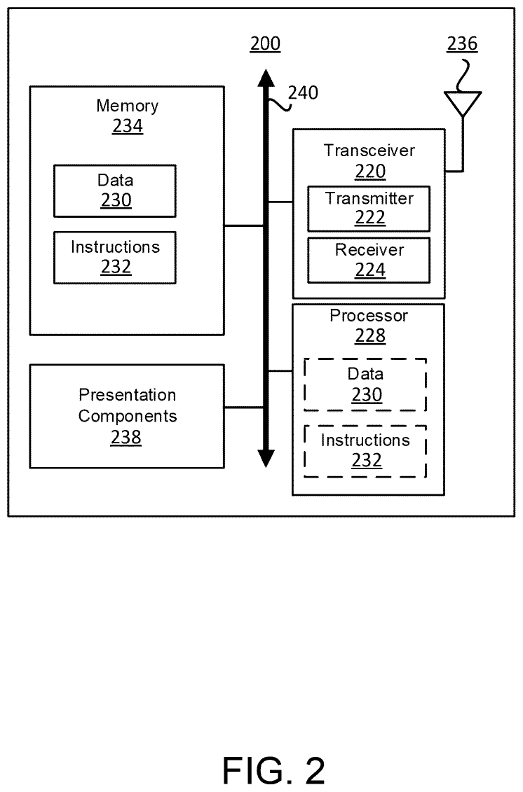

FIG. 2 is a block diagram illustrating a node 200 for wireless communication in accordance with various aspects of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable, and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes) that are configured to, when executed, cause the processor 228 to perform various functions disclosed herein, for example, with reference to FIG. 1. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the network communications module. The processor 228 may also process information to send to the transceiver 220 for transmission via the antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for a conditional handover (CHO) in a multi-radio access technology (RAT) dual connectivity (MR-DC) network, the method comprising:
receiving a message comprising an execution condition for a primary cell (PCell), a first secondary cell group (SCG) configuration for a first primary secondary cell (PSCell), an execution condition for the first PSCell, and a second SCG configuration for a second PSCell;
storing the first SCG configuration and the second SCG configuration;
determining whether the execution condition for the PCell is satisfied and whether the execution condition for the first PSCell is satisfied;
applying the first SCG configuration after determining that the execution condition for the PCell is satisfied and the execution condition for the first PSCell is satisfied; and
applying the second SCG configuration after determining that the execution condition for the PCell is satisfied and the execution condition for the first PSCell is not satisfied.

2. The method of claim 1, further comprising connecting, based on the first SCG configuration, to the first PSCell after determining that the execution condition for the PCell is satisfied and the execution condition for the first PSCell is satisfied.

3. The method of claim 1, further comprising connecting, based on the second SCG configuration, to the second PSCell after determining that the execution condition for the PCell is satisfied and the execution condition for the first PSCell is not satisfied.

4. The method of claim 1, wherein receiving the message comprises receiving the message via radio resource control (RRC) signaling.

5. A user equipment (UE) for a conditional handover (CHO) in a multi-radio access technology (RAT) dual connectivity (MR-DC) network, the UE comprising:
one or more processors; and
at least one non-transitory computer-readable medium coupled to at least one of the one or more processors, and storing one or more computer-executable instructions that, when executed by the at least one of the one or more processors, cause the UE to:
receive a message comprising an execution condition for a primary cell (PCell), a first secondary cell group (SCG) configuration for a first primary secondary cell (PSCell), an execution condition for the first PSCell, and a second SCG configuration for a second PSCell;
store the first SCG configuration and the second SCG configuration;
determine whether the execution condition for the PCell is satisfied and whether the execution condition for the first PSCell is satisfied;
apply the first SCG configuration after determining that the execution condition for the PCell is satisfied and the execution condition for the first PSCell is satisfied; and
apply the second SCG configuration after determining that the execution condition for the PCell is satisfied and the execution condition for the first PSCell is not satisfied.

6. The UE of claim 5, wherein the one or more computer-executable instructions, when executed by the at least one of the one or more processors, further cause the UE to connect, based on the first SCG configuration, to the first PSCell after determining that the execution condition for the PCell is satisfied and the execution condition for the first PSCell is satisfied.

7. The UE of claim 5, wherein the one or more computer-executable instructions, when executed by the at least one of the one or more processors, further cause the UE to connect, based on the second SCG configuration, to the second PSCell after determining that the execution condition for the PCell is satisfied and the execution condition for the first PSCell is not satisfied.

8. The UE of claim 5, wherein receiving the message comprises receiving the message via radio resource control (RRC) signaling.
